(19) United States
(12) Patent Application Publication
(10) Pub. No.: US 2011/0162468 A1
(43) Pub. Date: Jul. 7, 2011

(54) Coarse/fine adjustment linear displacement mechanism

(76) Inventor: Yu-Jen Lin, Taichung City (TW)

(21) Appl. No.: 12/654,852

(22) Filed: Jan. 6, 2010

(51) Int. Cl. G05G 11/00; F16H 25/20

(52) U.S. Cl. 74/89.29

(57) ABSTRACT

A coarse/fine adjustment linear displacement mechanism is disclosed to include a fixed holder frame, a movable holder frame movably supported on the fixed holder frame, a coarse adjustment screw rod threaded into a first screw hole on the fixed holder frame for rotation by the user to move the movable holder frame relative to the fixed holder frame rapidly and a fine adjustment threaded sleeve rotatably sleeved onto a smooth segment of the coarse adjustment screw rod and threaded into a second screw hole on the movable holder frame for rotation by the user to move the movable holder frame relative to the fixed holder frame at a fine scale. The coarse adjustment screw rod and the fine adjustment threaded sleeve are provided with different thread pitches for coarse adjustment and fine adjustment respectively, achieving rapid and accurate adjustments.

### BACKGROUND OF THE INVENTION

1. Field of the Invention

The present invention relates to linear displacement mechanisms and more particularly, to a coarse/fine adjustment linear displacement mechanism, which allows the user to manually adjust the position of a platform rapidly and accurately.

2. Description of the Related Art

Manual linear displacement mechanism is intensively used in microscopes, measuring apparatus and machine tools. A conventional linear displacement mechanism with fine/coarse adjustment, as disclosed in U.S. Pat. No. 4,919,001, includes a base block, a stage and a feed screw shaft. The feed screw shaft is rotatably mounted in the base block and meshed with a stage supporting member at the bottom side of the stage. For fast movement of the stage, the user can operate a coarse adjustment handle to rotate the feed screw shaft, causing the stage to be moved linearly. For fine displacement of the stage, the user needs to rotate a fine adjustment knob for causing the feed screw shaft to be rotated through rotation of multiple reducing gears, thereby achieving a fine displacement. Either coarse adjustment or fine adjustment of this design of linear displacement mechanism, the adjustment is performed through the same feed screw shaft. If the feed screw shaft has a small thread pitch, the speed of displacement of the stage during a coarse adjustment will be slow, and the user needs to rotate the feed screw shaft through several turns to move the stage to the desired location. However, if the feed screw shaft has a big thread pitch, the backlash between the outer thread of the feed screw shaft and the inner thread of the stage supporting member will be relatively increased, resulting in incomplete conversion of the rotation of the fine adjustment knob into displacement of the stage supporting member and lowering the precision of the fine displacement.

### SUMMARY OF THE INVENTION

The present invention has been accomplished under the circumstances in view. It is the main object of the present invention to provide a coarse/fine adjustment linear displacement mechanism, which uses a screw rod and a threaded sleeve with different thread pitches for coarse adjustment and fine adjustment respectively, achieving rapid and accurate adjustments.

To achieve this and other objects of the present invention, a coarse/fine adjustment linear displacement mechanism comprises a fixed holder frame, a movable holder frame, a coarse adjustment screw rod and a fine adjustment threaded sleeve. The fixed holder frame defines therein a first screw hole. The movable holder frame is movably supported on the fixed holder frame, defining therein a second screw hole. The coarse adjustment screw rod has a threaded segment threaded into the first screw hole and a smooth segment axially extended from one end of the threaded segment. The fine adjustment threaded sleeve is rotatably sleeved onto the smooth segment of the coarse adjustment screw rod and threaded into the second screw hole.

The coarse/fine adjustment linear displacement mechanism further comprising two bearings mounted between the smooth segment of the coarse adjustment screw rod and the fine adjustment threaded sleeve, a stop member meshed with the threaded segment of the coarse adjustment screw rod and a spring member sleeved onto the coarse adjustment screw rod and stopped between the stop member and the fixed holder frame.

Further, the fine adjustment threaded sleeve has an axial hole that accommodates the smooth segment of the coarse adjustment screw rod and the two bearings. The coarse adjustment screw rod has a coarse adjustment knob fixedly located on one end of the smooth segment. The coarse adjustment knob has an annular rib received inside the axial hole and stopped against one bearing.

Further, the fixed holder frame has an annular groove located around one end of the first screw hole and an annular rib disposed between the first screw hole and the annular groove. The annular rib has at least one notch. The stop member has at least one pawl engaged into the at least one notch. Further, the movable holder frame comprises a body and a connector. The second screw hole is formed in the connector of the movable holder frame. The connector of the movable holder frame comprises a radial split, a first free end and a second free end disposed at two opposite sides relative to the radial split, a screw hole located on the second free end and a holding-down bolt driven through the first free end and threaded into the screw hole on the second free end. Further, the threaded segment of the coarse adjustment screw rod has a multiple-start thread. Further, the threaded segment of the fine adjustment threaded sleeve has a single-start thread.

### BRIEF DESCRIPTION OF THE DRAWINGS

FIG. 1 is an elevational view of a coarse/fine adjustment linear displacement mechanism in accordance with a first embodiment of the present invention.

FIG. 2 is an exploded view of the coarse/fine adjustment linear displacement mechanism in accordance with the first embodiment of the present invention.

FIG. 3 is a sectional view of the coarse/fine adjustment linear displacement mechanism in accordance with the first embodiment of the present invention.

FIG. 4 is an enlarged view of a part of FIG. 3.

FIG. 5 is similar to FIG. 3, showing a status of the coarse/fine adjustment linear displacement mechanism after a fast displacement.

FIG. 6 is similar to FIG. 4, showing a status of the coarse/fine adjustment linear displacement mechanism after a fine displacement.

FIG. 7 is a partial sectional view of a coarse/fine adjustment linear displacement mechanism in accordance with a second embodiment of the present invention.

### DETAILED DESCRIPTION OF THE INVENTION

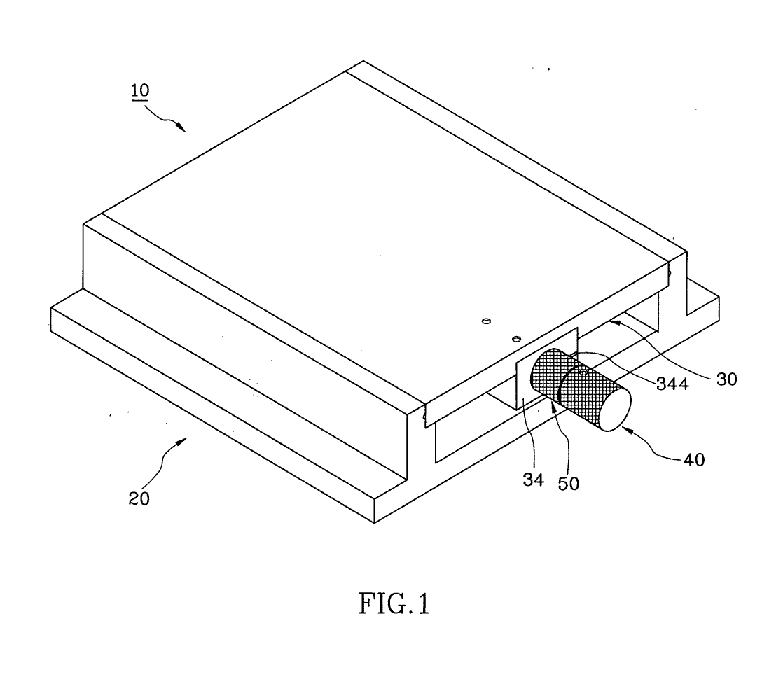

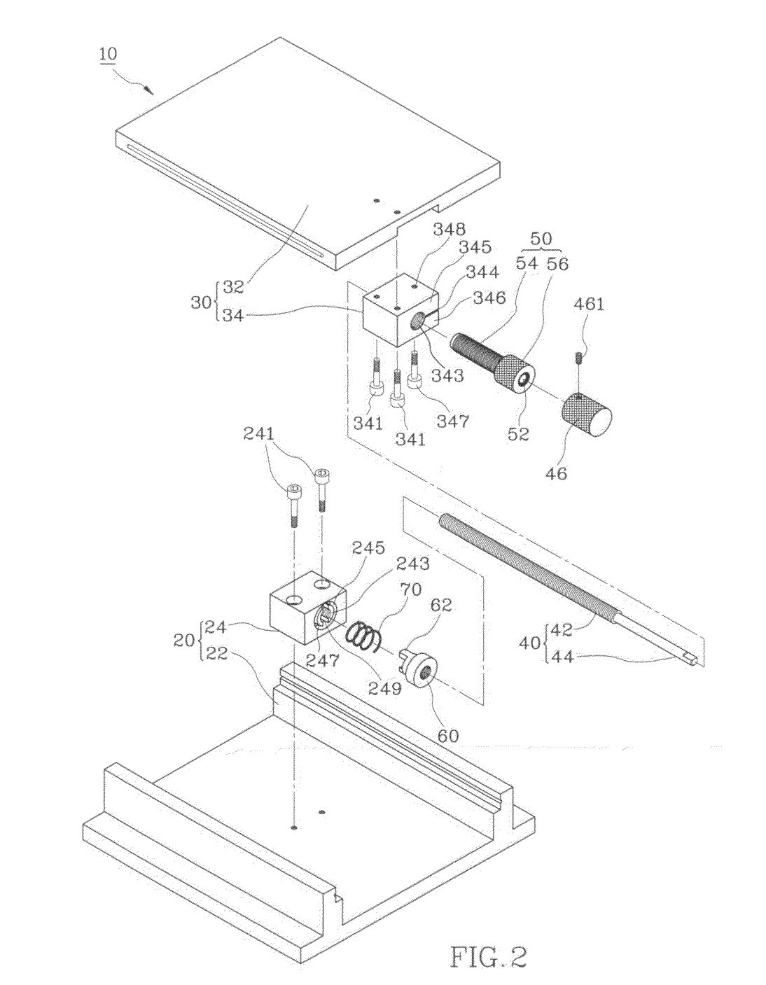

Referring to FIGS. 1-3, a coarse/fine adjustment linear displacement mechanism 10 in accordance with a first embodiment of the present invention comprises a fixed holder frame 20, a movable holder frame 30, a coarse adjustment screw rod 40, a fine adjustment threaded sleeve 50, a stop member 60 and a spring member 70.

The fixed holder frame 20 comprises a frame body 22, and a connector 24 affixed to the frame body 22 with two screw bolts 241. The connector 24 has a first screw hole 243, an annular groove 245 and an annular rib 247. The first screw hole 243 extends through two opposite sides of the connector 24. The annular groove 245 is located on one side of the connector 24 around one end of the first screw hole 243. The annular rib 247 is located on the same side of the connector 24 between the annular groove 245 and the first screw hole 243, having two notches 249.

The movable holder frame 30 comprises a frame body 32, and a connector 34 affixed to the frame body 32 with two screw bolts 341. The connector 34 has a second screw hole 343, a radial split 344, two free ends 345,346 and a holding-down bolt 347. The two free ends 345,346 are respectively disposed at two opposite sides relative to the radial split 344. The holding-down bolt 347 is driven through one free end 346 and threaded into a screw hole 348 on the other free end 345.

The coarse adjustment screw rod 40 has a threaded segment 42, a smooth segment 44 and a coarse adjustment knob 46. The threaded segment 42 is threaded into the first screw hole 243. The smooth segment 44 is integrally connected with one end of the threaded segment 42. The coarse adjustment knob 46 is affixed to one end of the smooth segment 44 remote from the threaded segment 42 by a lock screw 461.

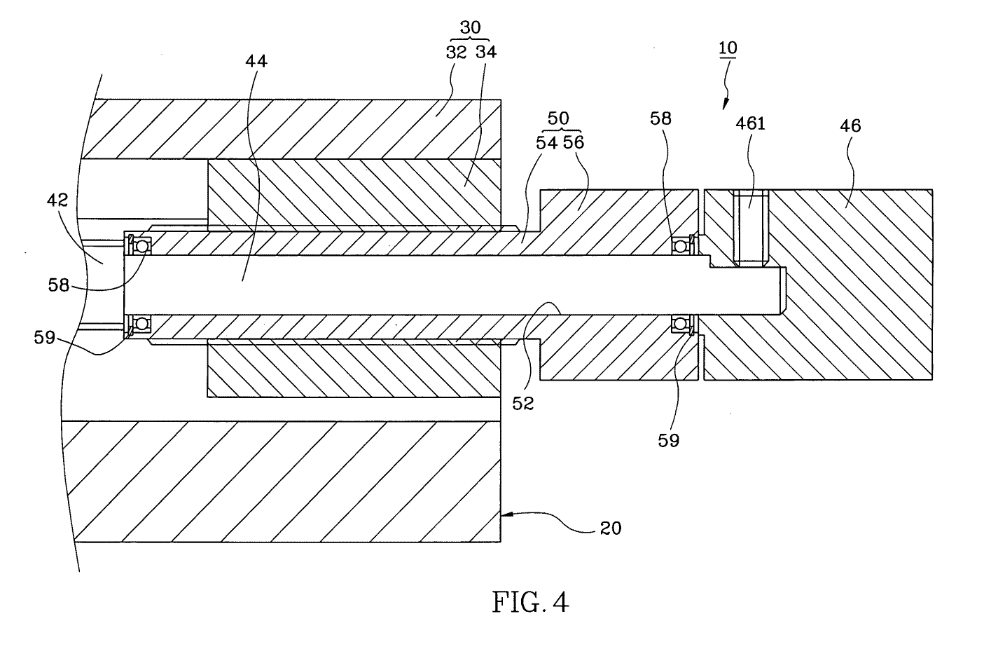

The fine adjustment threaded sleeve 50 has an axial hole 52. By means of the axial hole 52, the fine adjustment threaded sleeve 50 is sleeved onto the smooth segment 44 of the coarse adjustment screw rod 40. Further, the fine adjustment threaded sleeve 50 can be rotated relative to the coarse adjustment screw rod 40 but prohibited from an axial displacement relative to the coarse adjustment screw rod 40. Further, the fine adjustment threaded sleeve 50 has a threaded segment 54 and a fine adjustment knob 56 fixedly located on one end of the threaded segment 54. The thread pitch of the threaded segment 54 of the fine adjustment threaded sleeve 50 is smaller than the thread pitch of the threaded segment 42 of the coarse adjustment screw rod 40. Please refer also to FIG. 4. Two bearings 58 are provided between the coarse adjustment screw rod 40 and the fine adjustment threaded sleeve 50 to smooth relative rotation between the coarse adjustment screw rod 40 and the fine adjustment threaded sleeve 50. The two bearings 58 are respectively secured to the inside of the axial hole 52 of the fine adjustment threaded sleeve 50 by two C-shaped retainers 59.

The stop member 60 is meshed with the threaded segment 42 of the coarse adjustment screw rod 40, having two pawls 62 respectively engaged into the notches 249 on the annular rib 247 of the fixed holder frame 20.

The spring member 70 is sleeved onto the threaded segment 42 of the coarse adjustment screw rod 40 and stopped between the stop member 60 and the connector 24 of the fixed holder frame 20. One end of the spring member 70 is positioned in the annular groove 245 of the connector 24 of the fixed holder frame 20.

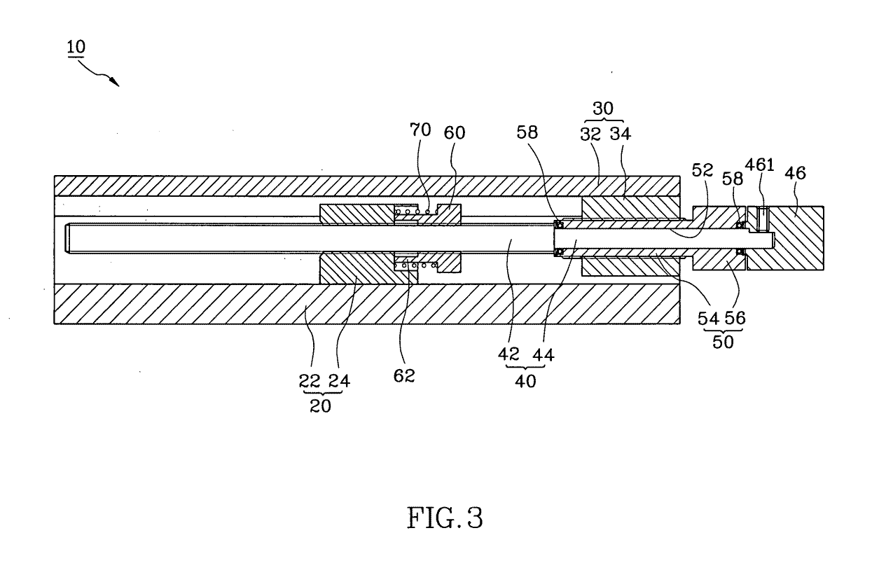

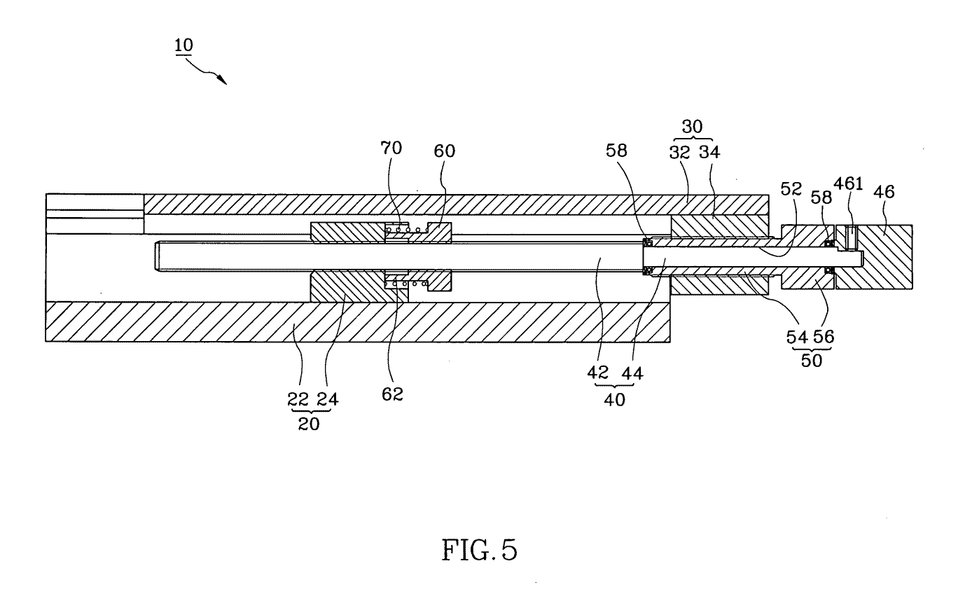

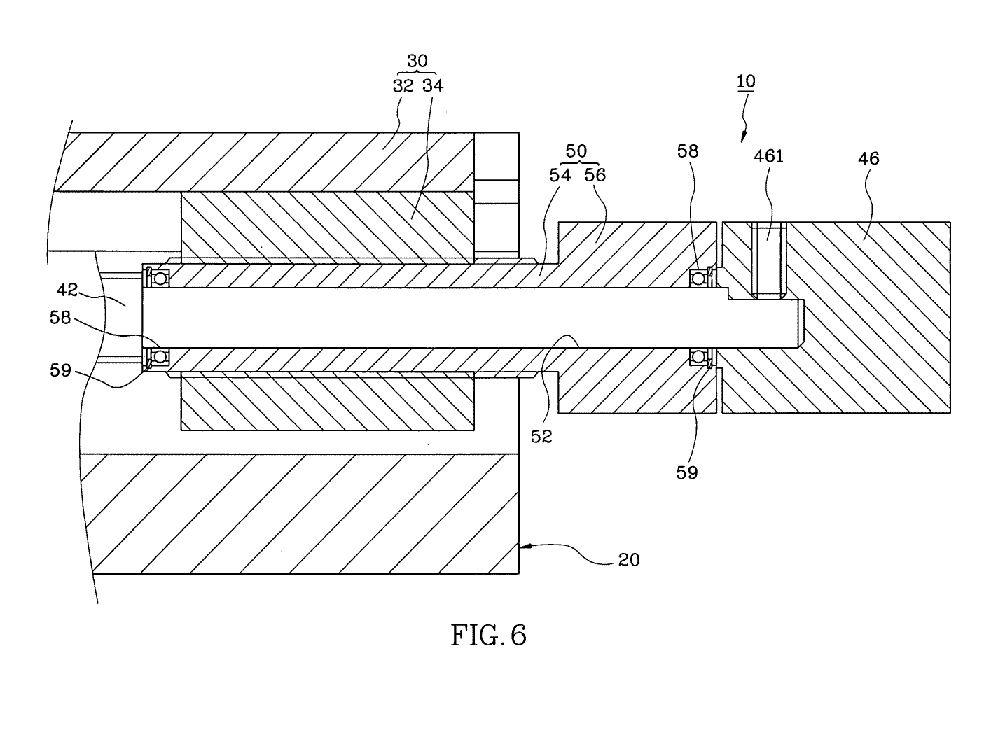

When wishing to move the movable holder frame 30 rapidly, as shown in FIG. 3 and FIG. 5, the user needs to operate the coarse adjustment knob 46 to rotate the coarse adjustment screw rod 40. Subject to engagement between the coarse adjustment screw rod 40 and the connector 24 of the fixed holder frame 20, the coarse adjustment rod 40 is moved axially when rotated by the user. At this time, the fine adjustment threaded sleeve 50 and the movable holder frame 30 are moved together with the coarse adjustment screw rod 40, achieving the desired displacement. When wishing to move the movable holder frame 30 at a fine scale, as shown in FIG. 4 and FIG. 6, the user simply needs to operate the fine adjustment knob 56 to rotate the fine adjustment threaded sleeve 50 on its own axis. Subject to engagement between the fine adjustment threaded sleeve 50 and the connector 34 of the movable holder frame 30 and immovable status of the coarse adjustment screw rod 40, the movable holder frame 30 is moved at a fine scale.

Because coarse adjustment and fine adjustment of the coarse/fine adjustment linear displacement mechanism 10 are driven by the coarse adjustment screw rod 40 and the fine adjustment threaded sleeve 50 respectively, the designer can expand the thread pitch of the coarse adjustment screw rod 40 or design a multiple-start thread on the coarse adjustment screw rod 40 to facilitate fast displacement of the movable holder frame 30. Further, the designer can design a single-start thread on the fine adjustment threaded sleeve 50, facilitating machining of the thread pitch to reduce the tolerance and to improve the precision of micro displacement.

Referring to FIG. 3 again, the stop member 60 and the spring member 70 provide an axial force between the coarse adjustment screw rod 40 and the connector 24 of the fixed holder frame 20 to eliminate the backlash between the outer thread of the coarse adjustment screw rod 40 and the inner thread of the connector 24 for enabling rotation of the coarse adjustment screw rod 40 to be fully converted into displacement of the movable holder frame 30. Further, when the threads of the coarse/fine adjustment linear displacement mechanism 10 start to wear after a long use, the user can rotate the holding-down bolt 347 of the movable holder frame 30 to move the two free ends 345,346 toward each other, reducing the radial backlash between the outer thread of the fine adjustment threaded sleeve 50 and the inner thread of the connector 34.

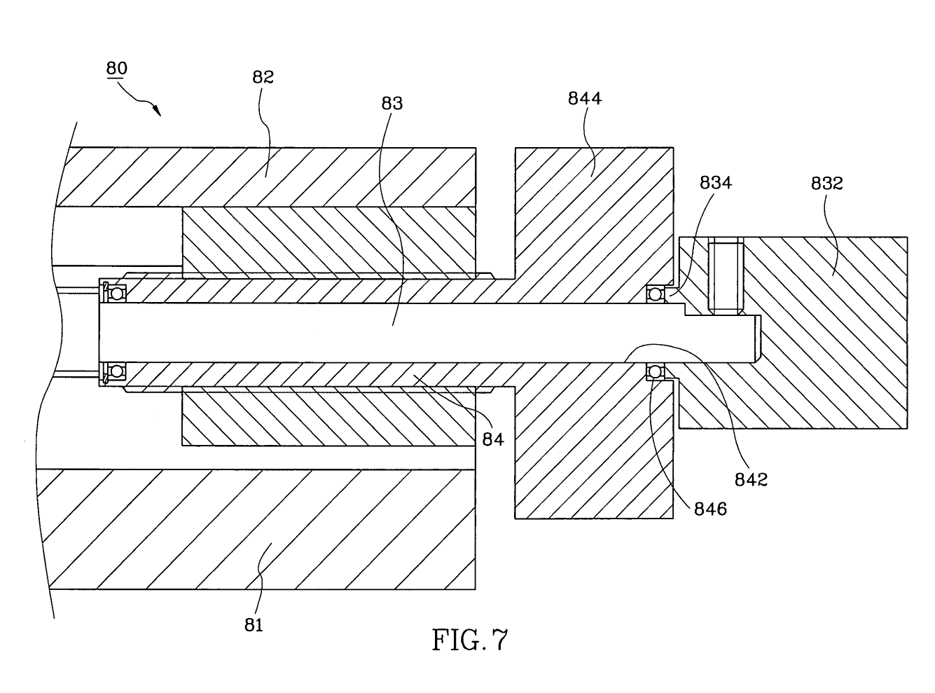

Based on the spirit of the present invention, the coarse/fine adjustment linear displacement mechanism may be variously embodied. FIG. 7 illustrates a coarse/fine adjustment linear displacement mechanism 80 in accordance with a second embodiment of the present invention. Similar to the aforesaid first embodiment, the coarse/fine adjustment linear displacement mechanism 80 comprises a fixed holder frame 81, a movable holder frame 82, a stop member (not shown) and a spring member (not shown). According to this second embodiment, the size of the fine adjustment knob 844 of the fine adjustment threaded sleeve 84 is enlarged, facilitating the user to rotating the fine adjustment knob 844. Further, the coarse adjustment knob 832 of the coarse adjustment screw rod 83 has an annular rib 834 engaged into the axial hole 842 of the fine adjustment threaded sleeve 84 and stopped against a adjacent bearing 846.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A coarse/fine adjustment linear displacement mechanism, comprising:
a fixed holder frame, said fixed holder frame defining therein a first screw hole;
a movable holder frame movably supported on said fixed holder frame, said movable holder frame defining therein a second screw hole;
a coarse adjustment screw rod, said coarse adjustment screw rod having a threaded segment threaded into said first screw hole and a smooth segment axially extended from one end of said threaded segment; and
a fine adjustment threaded sleeve rotatably sleeved onto said smooth segment of said coarse adjustment screw rod and threaded into said second screw hole.

2. The coarse/fine adjustment linear displacement mechanism as claimed in claim 1, further comprising two bearings mounted between said smooth segment of said coarse adjustment screw rod and said fine adjustment threaded sleeve.

3. The coarse/fine adjustment linear displacement mechanism as claimed in claim 2, wherein said fine adjustment threaded sleeve has an axial hole that accommodates said smooth segment of said coarse adjustment screw rod and said two bearings; said coarse adjustment screw rod has a coarse adjustment knob fixedly located on one end of said smooth segment, said coarse adjustment knob having an annular rib received inside said axial hole and stopped against one said bearing.

4. The coarse/fine adjustment linear displacement mechanism as claimed in claim 1, further comprising a stop member meshed with said threaded segment of coarse adjustment screw rod and a spring member sleeved onto said coarse adjustment screw rod and stopped between said stop member and said fixed holder frame.

5. The coarse/fine adjustment linear displacement mechanism as claimed in claim 4, wherein said fixed holder frame has an annular groove located around one end of said first screw hole and an annular rib disposed between said first screw hole and said annular groove, said annular rib having at least one notch; said stop member has at least one pawl engaged into said at least one notch.

6. The coarse/fine adjustment linear displacement mechanism as claimed in claim 1, wherein said movable holder frame comprises a body and a connector; said second screw hole is formed in the connector of said movable holder frame; the connector of said movable holder frame comprises a radial split, a first free end and a second free end disposed at two opposite sides relative to said radial split, a screw hole located on said second free end and a holding-down bolt driven through said first free end and threaded into the screw hole on said second free end.

7. The coarse/fine adjustment linear displacement mechanism as claimed in claim 1, wherein said threaded segment of said coarse adjustment screw rod has a multiple-start thread.

8. The coarse/fine adjustment linear displacement mechanism as claimed in claim 1, wherein said threaded segment of said fine adjustment threaded sleeve has a single-start thread.
